(19) United States
(12) Patent Application Publication
(10) Pub. No.: US 2007/0287057 A1
(43) Pub. Date: Dec. 13, 2007

(54) Method for making a hydrophilic corrosion resistant coating on low grade stainless steel/alloys for bipolar plates

(76) Inventors: Mahmoud H. Abd Elhamid, Grosse Pointe Woods, MI (US); Youssef M. Mikhail, Sterling Heights, MI (US); Richard H. Blunk, Macomb Township, MI (US); Upendra Rao, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/450,793

(22) Filed: Jun. 9, 2006

(51) Int. Cl. H01M 8/02; B05D 5/12; C04B 35/64; B32B 3/30

(52) U.S. Cl. 429/38; 427/115; 427/383.3; 264/614; 428/167

(57) ABSTRACT

A stainless steel flow field plate for a fuel cell that includes a layer of titanium or titanium oxide and a layer of titanium oxide/ruthenium oxide that makes the plate conductive and hydrophilic. In one embodiment, titanium is deposited on the surface of a stainless steel bipolar plate as a metal or an oxide using a suitable process, such as PVD or CVD. A solution of ruthenium chloride in ethanol is brushed on the titanium layer. The plate is then calcinated to provide a dimensionally stable titanium oxide/ruthenium oxide layer on the stainless steel that is hydrophilic and electrically conductive in the fuel cell environment.

### BACKGROUND OF THE INVENTION

1. Field of the Invention

This invention relates generally to bipolar plates for fuel cells and, more particularly, to a bipolar plate for a fuel cell, where the bipolar plate is made of stainless steel and includes a coating of titanium oxide and a coating of ruthenium oxide so as to make the plate electrically conductive, corrosion resistant, hydrophilic and stable in a fuel cell environment.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired power. For the automotive fuel cell stack mentioned above, the stack may include two hundred or more fuel cells. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is not conductive, and thus increases the internal resistance of the fuel cell, reducing its electrical performance. Also, the oxide layer makes the plate more hydrophobic. It is known in the art to deposit a thin layer of a conductive material, such as gold, on the bipolar plates to reduce the contact resistance between the plate and diffusion media in the fuel cells.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², the water may accumulate within the flow channels because the flow rate of the reactant gas is too low to force the water out of the channels. As the water accumulates, it forms droplets that continue to expand because of the relatively hydrophobic nature of the plate material. The droplets form in the flow channels substantially perpendicular to the flow of the reactant gas. As the size of the droplets increases, the flow channel is closed off, and the reactant gas is diverted to other flow channels because the channels are in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the cathode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It has been proposed in the art to make bipolar plates for a fuel cell hydrophilic to improve channel water transport. A hydrophilic plate causes water in the channels to form a thin film that has less of a tendency to alter the flow distribution along the array of channels connected to the common inlet and outlet headers. If the plate material is sufficiently wettable, water transport through the diffusion media will contact the channel walls and then, by capillary force, be transported into the bottom corners of the channel along its length. The physical requirements to support spontaneous wetting in the corners of a flow channel are described by the Concus-Finn condition,

$$β + \frac{α}{2} < 90 ° ,$$

where β is the static contact angle and α is the channel corner angle. For a rectangular channel α/2=45°, which dictates that spontaneous wetting will occur when the static contact angle is less than 45°. For the roughly rectangular channels used in current fuel cell stack designs with composite bipolar plates, this sets an approximate upper limit on the contact angle needed to realize the beneficial effects of hydrophilic plate surfaces on channel water transport and low load stability.

It has been proposed in the art to deposit a layer of titanium oxide on a bipolar plate to make the plate hydrophilic. Further, it has been suggested in the art to make the titanium oxide conductive by depositing a gold layer on the titanium oxide layer. However, gold has become very expensive in recent years. Therefore, it would be desirable to provide another combination of materials to make the bipolar plate hydrophilic and electrically conductive so as to save cost.

### SUMMARY OF THE INVENTION

In accordance with the teachings of the present invention, a flow field plate or bipolar plate for a fuel cell is disclosed that includes a layer of titanium or titanium oxide and a layer of titanium oxide/ruthenium oxide that makes the plate conductive and hydrophilic. In one embodiment, titanium is deposited on the surface of a stainless steel bipolar plate as a metal or an oxide using a suitable process, such as PVD or CVD. A solution of ruthenium chloride in alcohol is brushed on to the titanium layer. The plate is then calcinated at a suitable temperature for a suitable period of time to provide a layer of titanium or titanium oxide on the stainless steel substrate and a dimensionally stable ruthenium oxide/titanium oxide layer on the titanium or titanium oxide layer that make the plate hydrophilic and electrically conductive in the fuel cell environment.

Additional features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack that includes bipolar plates having a titanium oxide layer and a ruthenium oxide layer that makes the bipolar plate hydrophilic and electrically conductive; and

FIG. 2 is a flow chart diagram showing a process for depositing the titanium oxide layer and the ruthenium oxide layer on the bipolar plate.

### DETAILED DESCRIPTION OF THE EMBODIMENTS

The following discussion of the embodiments of the invention directed to a bipolar plate for a fuel cell that includes a titanium oxide layer and a ruthenium oxide layer that makes the bipolar plate hydrophilic and electrically conductive in a fuel cell environment is merely exemplary in nature, and is in no way intended to limit the invention or its applications or uses.

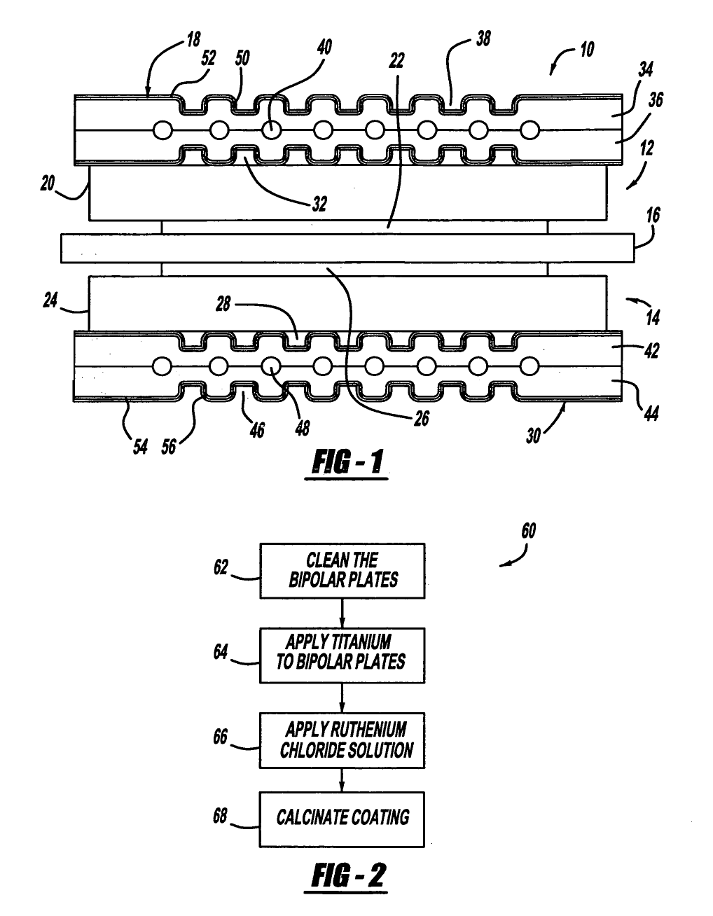

FIG. 1 is a cross-sectional view of a fuel cell 10 that is part of a fuel cell stack of the type discussed above. The fuel cell 10 includes a cathode side 12 and an anode side 14 separated by a perfluorosulfonic acid membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. The bipolar plates 18 and 30 are provided between the fuel cells in the fuel cell stack. A hydrogen reactant gas flow from flow channels 28 in the bipolar plate 30 reacts with the catalyst layer 26 to dissociate the hydrogen ions and the electrons. Airflow from flow channels 32 in the bipolar plate 18 reacts with the catalyst layer 22. The hydrogen ions are able to propagate through the membrane 16 where they carry the ionic current through the membrane. The by-product of this electro-chemical reaction is water.

In this non-limiting embodiment, the bipolar plate 18 includes two sheets 34 and 36 that are formed separately and then joined together. The sheet 36 defines the flow channels 32 and the sheet 34 defines flow channels 38 for the anode side of an adjacent fuel cell to the fuel cell 10. Cooling fluid flow channels 40 are provided between the sheets 34 and 36, as shown. Likewise, the bipolar plate 30 includes a sheet 42 defining the flow channels 28, a sheet 44 defining flow channels 46 for the cathode side of an adjacent fuel cell, and cooling fluid flow channels 48. In the embodiments discussed herein, the sheets 34, 36, 42 and 44 are made of an electrically conductive material, such as stainless steel, titanium, aluminum, polymeric carbon composites, etc.

According to one embodiment of the present invention, the bipolar plate 18 includes a titanium or titanium oxide layer 50 and a titanium oxide/ruthenium oxide layer 52, and the bipolar plate 30 includes a titanium or titanium oxide layer 54 and a titanium oxide/ruthenium oxide layer 56 that makes the plates 18 and 30 conductive, corrosion resistant, hydrophilic and stable in the fuel cell environment. The titanium or titanium oxide layers 50 and 54 protect the plate substrate from aggressive ruthenium chloride ions and the titanium oxide/ruthenium oxide layers 52 and 56 make the plates 18 and 30 hydrophilic and electrically conductive. The hydrophilicity of the layers 52 and 56 causes the water within the flow channels 28 and 32 to form a film instead of water droplets so that the water does not significantly block the flow channels. Particularly, the hydrophilicity of the layers 52 and 56 decreases the contact angle of water accumulating the flow channels 32, 38, 28 and 46 so that the reactant gases deliver the flow through the channels at low loads. In one embodiment, the contact angle of water is below 30° and preferably about 10°.

By making the bipolar plates 18 and 30 more conductive, the electrical contact resistance between the fuel cells and the losses in the fuel cell are reduced, thus increasing cell efficiency. Also, an increase in the conductivity provided by the layers 52 and 56 provides a reduction in compression force in the stack, addressing certain durability issues within the stack.

Also, the layers 50, 52, 54 and 56 are stable, i.e., corrosion resistant. The hydrofluoric acid generated as a result of degradation of the perfluorosulfonic ionomer in the membrane 16 during operation of the fuel cell 10 does not corrode the layers 50, 52, 54 and 56.

When the layers 50-56 are deposited on the bipolar plate 30, they can be deposited on the sides of the sheets 42 and 44 where the cooling fluid flow channels 48 are provided so that the sheets 42 and 44 do not need to be welded together. This is because the ruthenium oxide provides a good ohmic contact between the sheets for the conduction of electricity. Therefore, instead of the laser welding that would bond the plates and provide the electrical contact between the sheets in the prior art, the sheets need only be sealed around the edges to seal the bipolar plates.

In an alternate embodiment, the layers 50 and 54 can be tantalum oxide and the layers 52 and 56 can be tantalum oxide/iridium oxide that also makes the plates 18 and 30 electrically conductive, corrosion resistant, hydrophilic and stable in the fuel cell environment.

The layers 50, 52, 54 and 56 can be deposited on the bipolar plates 18 and 30 by any suitable process. FIG. 2 is a flow chart diagram showing one process of depositing the layers 50, 52, 54 and 56, according to an embodiment of the present invention. At box 62, the bipolar plates 18 and 30 are cleaned by a suitable process, such as ion beam sputtering, to remove the resistant oxide film on the outside of the plates 18 and 30 that may have formed. Then, a coating of titanium is applied to the bipolar plates 18 and 30 at box 64 as a metal or an oxide. Any suitable process can be used to deposit the titanium on the bipolar plates 18 and 30, such as physical vapor deposition (PVD) or chemical vapor deposition (CVD).

Next, a ruthenium chloride solution is applied to the titanium coating. In one non-limiting embodiment, the ruthenium chloride solution is ruthenium chloride dissolved in an ethanol. The ruthenium chloride solution can be applied to the bipolar plates 18 and 30 by any suitable process, such as by brushing.

The titanium coating and the ruthenium chloride solution are then calcinated at a predetermined temperature for a predetermined period of time to develop a dimensionally stable ruthenium oxide/titanium oxide coating on the bipolar plates 18 and 30 that is hydrophilic and electrically conductive in the fuel cell environment. In one embodiment, the titanium and the ruthenium chloride solution are calcinated at about 450° C. for about 10 minutes. Titanium and ruthenium have almost identical crystalline structures. When the ruthenium chloride is deposited on the titanium or titanium oxide layer and calcinated, a bottom layer of titanium or titanium oxide and a top layer of titanium oxide/ruthenium oxide is formed. Because of the properties of the titanium oxide and the ruthenium oxide as discussed herein, the stainless steel used to make the bipolar plates 18 and 30 can be low grade. The thickness of the titanium or titanium oxide layer can be in the range of 10-500 nm and the thickness of the titanium oxide/ruthenium oxide layer can be in the range of 1 nm-50 nm.

After the calcination process, the different phases of the titanium oxide layer and the ruthenium oxide layer are combined as one phase, i.e., they form an extensive solid solution. The titanium oxide provides the hydrophilicity and the ruthenium oxide provides the conductivity. Further, because ruthenium oxide does not adhere well to stainless steel, the titanium or titanium oxide allows the ruthenium oxide to be deposited on stainless steel bipolar plates. Also, during the calcination process, the ruthenium chloride is converted to ruthenium oxide. The titanium layer is applied to the stainless steel prior to applying the ruthenium chloride to the stainless steel to protect the stainless steel against the aggressive nature of the chloride ions at the calcination temperature. Without the ruthenium chloride applied to the titanium layer, the process would also oxidize the titanium and convert it to titanium oxide, which is electrically non-conductive.

Table I shows the total resistance for a bipolar plate coated with a ruthenium oxide/titanium oxide layer in the manner as discussed above at different compression pressures, and Table II shows contact resistances for a bipolar plate including a titanium oxide layer on a stainless bipolar plate without the titanium oxide/ruthenium oxide layer with the same compression pressures. The contact resistance advantages of the ruthenium oxide are apparent.

TABLE I
Values for the Total Resistance Measured on Two Coupons Coated With
Titanium Oxide/Ruthenium Oxide
Placed Top to Bottom and in Between Two Carbon Papers

| | Total |
|---|---|
| Compression Pressure, PSI | Resistance Include Bond Line, MOHM CM² |
| 25 | 35 |
| 50 | 20.7 |
| 100 | 14.6 |
| 150 | 12 |
| 200 | 11.7 |

TABLE II
Values for the Total Resistance Measured on a Stainless Steel Sample
Coated With Titanium Oxide Alone and Placed Between Two Carbon
Papers

| Compression Pressure, PSI | Total Measured Resistance, MOHM CM² |
|---|---|
| 25 | 1950 |
| 50 | 1650 |
| 100 | 1120 |
| 150 | 816 |
| 200 | 623 |

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising a flow field plate being made of a plate material, said flow field plate including a plurality of reactant gas flow channels responsive to a reactant gas, said flow field plate further including a titanium or titanium oxide layer on the plate and a titanium oxide/ruthenium oxide layer on the titanium or titanium oxide layer that make the plate electrically conductive, hydrophilic and stable in a fuel cell environment.

2. The fuel cell according to claim 1 wherein the plate material is stainless steel.

3. The fuel cell according to claim 1 wherein the titanium or titanium oxide layer has a thickness in the range of 10-500 nm and the titanium oxide/ruthenium oxide layer has a thickness in the range of 1-50 nm.

4. The fuel cell according to claim 1 wherein the flow field plate is selected from the group consisting of anode side flow field plates and cathode side flow field plates.

5. The fuel cell according to claim 1 wherein the flow field plate includes two stamped sheets defining cooling fluid flow channels therebetween, and wherein the titanium oxide layer and the ruthenium oxide layer are provided on both sides of the sheets.

6. The fuel cell according to claim 1 wherein the titanium oxide/ruthenium oxide layer provides a water contact angle in the flow channels below 30°.

7. The fuel cell according to claim 1 wherein the fuel cell is part of a fuel cell stack on a vehicle.

8. A fuel cell comprising:
an anode side flow field plate being made of a stainless steel, said anode side flow field plate including a plurality of reactant gas flow channels responsive to a reactant gas, said anode side flow field plate further including a titanium or titanium oxide layer on the plate and a titanium oxide/ruthenium oxide layer on the titanium or titanium oxide layer; and
a cathode side flow field plate being made of a stainless steel, said cathode side flow field plate including a plurality of reactant gas flow channels responsive to a reactant gas, said cathode side flow field plate further including a titanium or titanium oxide layer on the plate and a titanium oxide/ruthenium oxide layer on the titanium or titanium oxide layer, wherein the titanium or titanium oxide layers and the titanium oxide/ruthenium oxide layers make the plates electrically conductive, hydrophilic and stable in the fuel cell environment.

9. The fuel cell according to claim 8 wherein the titanium or titanium oxide layer has a thickness in the range of 10-500 nm and the titanium oxide/ruthenium oxide layer has a thickness in the range of 1-50 nm.

10. The fuel cell according to claim 8 wherein the flow field plates include two stamped sheets defining cooling fluid flow channels therebetween, and wherein the titanium or titanium oxide layer and the titanium oxide/ruthenium oxide layer are provided on both sides of the sheets.

11. The fuel cell according to claim 8 wherein the titanium oxide/ruthenium oxide layers provides a water contact angle in the flow channels below 30°.

12. The fuel cell according to claim 8 wherein the fuel cell is part of a fuel cell stack on a vehicle.

13. A fuel cell comprising a flow field plate being made of a plate material, said flow field plate including a plurality of reactant gas flow channels responsive to a reactant gas, said flow field plate further including a tantalum oxide layer and a tantalum oxide/iridium oxide layer that make the plate electrically conductive, hydrophilic and stable in a fuel cell environment.

14. The fuel cell according to claim 13 wherein the plate material is stainless steel.

15. A method for making a flow field plate for a fuel cell, said method comprising:
providing a flow field plate structure including a plurality of reactant gas flow channels;
depositing a coating of titanium as a metal or an oxide on the flow field plate structure;
depositing a ruthenium chloride solution on the titanium or titanium oxide coating; and
calcinating the bipolar plate structure so that the titanium coating and the ruthenium chloride solution are converted to a titanium oxide/ruthenium oxide layer that make the flow field plate electrically conductive, hydrophilic and stable in the fuel cell environment.

16. The method according to claim 15 wherein providing a flow field plate structure includes providing a flow field plate structure being made of stainless steel.

17. The method according to claim 15 wherein providing a flow field plate structure includes providing a flow field plate structure including two stamped sheets defining cooling fluid channels therebetween, and wherein depositing a coating of titanium and a ruthenium chloride solution and calcinating the titanium coating and the ruthenium chloride solution includes performing the processes on both sides of the sheet.

18. The method according to claim 15 wherein depositing a coating of titanium includes depositing a coating of titanium on the flow field plate structure by a physical vapor deposition or chemical vapor deposition process.

19. The method according to claim 15 wherein depositing the ruthenium chloride solution includes brushing the ruthenium chloride solution on the titanium coating.

20. The method according to claim 15 wherein calcinating the flow field plate structure includes calcinating the flow field plate structure at a temperature of about 450° C.
